(19) United States
(12) Patent Application Publication
(10) Pub. No.: US 2006/0152848 A1
(43) Pub. Date: Jul. 13, 2006

(54) Recording disk driving motor and recording disk driving apparatus having the same

(75) Inventor: Yoshiki Okayama, Minami-ku (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nidec Corporation, Kyoto (JP)

(21) Appl. No.: 11/033,799

(22) Filed: Jan. 13, 2005

(51) Int. Cl. G11B 17/02

(52) U.S. Cl. 360/99.08

(57) ABSTRACT

A recording disk driving motor and a recording disk driving apparatus having the motor are disclosed. The recording disk driving motor comprises a position restricting portion between a fastening member and the upper part of the motor to restrict the amount by which the fastening member is fastened axially downward. Thus, the pressure transferred from the fastening member to a clamp member fails to be directly transferred to a thrust bearing section through a rotor upper wall portion.

### BACKGROUND OF THE INVENTION

1. Field of the Invention

The present invention relates to a recording disk driving motor having a fluid dynamic bearing for driving a recording disk such as a hard disk and a recording disk driving apparatus having the recording disk driving motor.

2. Description of the Prior Art

In recent years, a recording disk driving motor, having a structure such as shown in FIG. 6, making up a hard disk drive (HDD) used mainly for the personal computer has come to be developed. This recording disk driving motor comprises a bracket 502 having a central cylindrical portion 502a and a stator 504 fixedly held on the outer periphery of the cylindrical portion 502a. A sleeve 506 is fixedly held on the inner periphery of the cylindrical portion 502a.

A sleeve 506 and a shaft 508 constituting a rotary member are arranged in radially opposed relation with each other through an upper radial bearing section 526 and a lower radial bearing section 528. The upper end surface 506a of the sleeve 506 and the lower surface of the rotor upper wall portion 512a of a rotor hub 512 fixed on the upper part of the shaft 508 are arranged in axially opposed relation to each other through a thrust bearing section 514.

A rotor peripheral wall portion 512b extended in axial direction is formed on the outer periphery of the rotor hub 512, and a rotor magnet 516 radially opposed to the stator 504 is fixed on the inner peripheral surface of the rotor peripheral wall portion 512b.

A rotor flange portion 512c is formed on the rotor peripheral wall portion 512b, and one or a plurality of recording disks 518 are fixed on the outer peripheral surface of the rotor peripheral wall portion 512b using a spacer 520 having an annular shape, a clamp member 522 and a fastening member 524. Specifically, the threaded portion of the fastening member 524 is screwed into the threaded hole 508a formed in the shaft 508, so that the flange portion of the fastening member 524 comes into contact with the base 522a of the clamp member 522. Thus, the base 522a is pushed down along the axial direction, and comes into contact with the upper end surface of the rotor upper wall portion 512a. The pressure of the fastening member 524 is transmitted from the base 522a of the clamp member 522 to the operating section 522b arranged radially outward of the base 522a, and the operating section 522b holds the recording disk 518 and the spacer 520 with the upper surface of the rotor flange portion 512c.

However, in the structure for fixing the recording disk 518 by fastening the fastening member 524 described above, when the recording disk 518 is mounted on the rotor hub 512, the rotor upper wall portion 512a would be considerably deformed by the pressure imparted axially downward from the fastening member 524 to the clamp member 522 and further transmitted to the rotor upper wall portion 512a through the clamp member 522.

The rotor upper wall portion 512a, once deformed, would be displaced and the axial gap of the thrust bearing section 514 becomes uneven in size, and it would become difficult to secure a stable axial supporting force of the thrust bearing section 514. As a result, the rotational speed of the motor would be adversely affected, and the lower surface of the rotor upper wall portion 512a making up the thrust bearing section 514 comes into contact with the upper end surface 506a of the sleeve, with the result that the bearing surface would be worn, damaged or burned, thereby reducing the durability and reliability of the motor.

### SUMMARY OF THE INVENTION

An object of the present invention is to prevent the bearing from being affected by the pressure of the clamp member acting on the rotor hub.

Another object of the present invention is to provide a recording disk driving motor having a high durability and reliability and a recording disk driving apparatus having the recording disk driving motor, in which the highly accurate rotation of the motor is maintained by securing a substantially uniform gap of the thrust dynamic bearing.

According to one aspect of the present invention, there is provided a recording disk driving motor comprising a sleeve, a bracket for fixing the sleeve and a stator fixed on the outer peripheral surface of the sleeve or the bracket. And the motor according to the present invention comprises: a shaft rotating around a rotational axis relatively to the sleeve, having a threaded hole formed on an upper end surface of the shaft and extending downward on the rotational axis in the shaft, the threaded hole to which the fastening member is fastened; a rotor hub fixed on the axially upper part of the shaft, including a rotor upper wall portion and a rotor peripheral wall portion extending downward in axial direction from an outer periphery of the rotor upper wall portion, an outer peripheral surface of the rotor upper wall portion on which the recording disk is held; and a rotor magnet fixed on the rotor peripheral wall portion.

A lubricating fluid is retained in a first micro gap between the lower surface of the rotor upper wall portion and the upper end surface of the sleeve. The first micro gap has formed therein a thrust bearing section having dynamic pressure generating grooves for generating a dynamic pressure in the lubricating fluid when the shaft or the sleeve rotates.

A position restricting portion for restricting the amount, by which the fastening member is fastened in the threaded hole, is formed between the fastening member and the upper part of the motor. When the fastening member is fastened, therefore, the pressure of the clamp member pressed by the fastening member is not directly transmitted to the thrust bearing section through the rotor upper wall portion. As a result, the first micro gap of the thrust bearing section can be maintained at a substantially uniform size, and therefore the axial supporting force of the thrust bearing section can be secured in stable fashion.

In this way, a recording disk driving motor high in durability and reliability is provided.

### BRIEF DESCRIPTION OF THE DRAWINGS

FIG. 1 is a sectional view showing a first embodiment of the invention.

FIG. 2 is an enlarged sectional view of the essential parts according to the first embodiment of the invention.

FIG. 3 is an enlarged sectional view of the essential parts according to a second embodiment of the invention.

FIG. 4 is an enlarged sectional view of the essential parts according to a third embodiment of the invention.

FIG. 5 is a sectional view showing a recording disk driving apparatus according to the invention.

FIG. 6 is a sectional view showing the conventional recording disk driving motor.

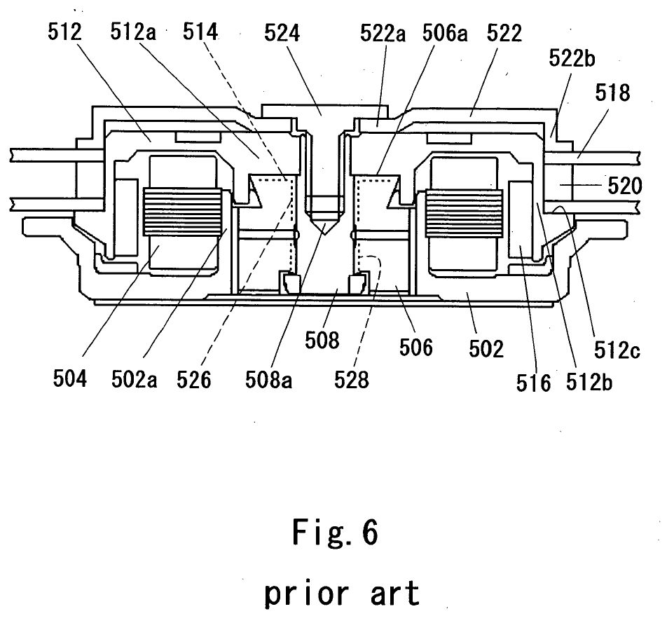

### DESCRIPTION OF THE PREFERRED EMBODIMENTS

Each embodiment of the invention is explained below with reference to the drawings. In the description that follows, the relative positions and the directions in which the members are arranged are always based on the page but not with regard to the members actually installed or built in other equipment.

### First Embodiment

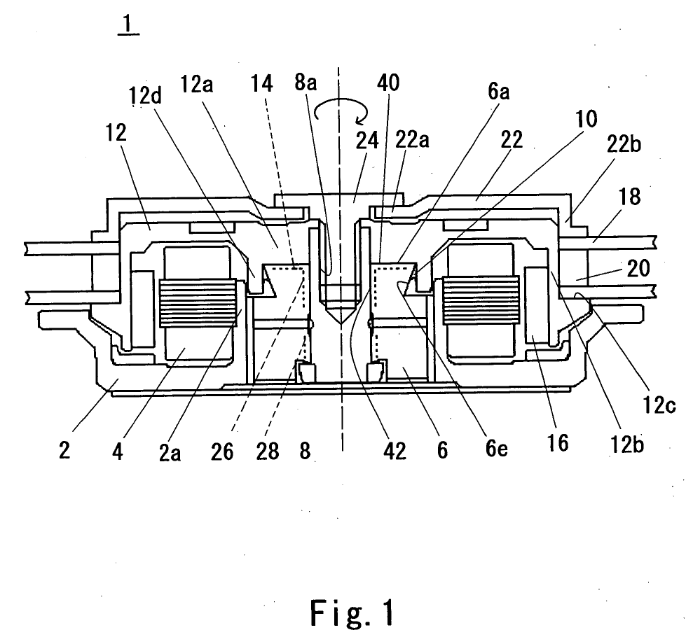

FIG. 1 is a sectional view showing an embodiment of the invention.

A recording disk driving motor according to the invention comprises a rotor hub 12, a shaft 8 integrally rotated with the rotor hub 12, a clamp member 22 held under the pressure of a fastening member 24, a sleeve 6 with the shaft 8 inserted therethrough for rotatably supporting the shaft 8 through upper and lower radial bearing sections 26, 28, and a bracket 2 formed integrally with a cylindrical portion 2a for fixedly holding the sleeve 6.

The rotor hub 12 includes a substantially disk-shaped rotor upper wall portion 12a, a cylindrical rotor peripheral wall portion 12b extending downward in axial direction form an outer periphery of the rotor upper wall portion 12a and having the recording disk 18 held on an outer periphery thereof, and a flange portion 12c expanded in radial direction from the rotor peripheral wall portion 12b.

A stator 4 is fixed on an outer periphery of the cylindrical portion 2a of the bracket 2, and the sleeve 6 is fixed on an inner periphery thereof. The stator 4 is arranged in radially opposed, through a radial gap, to a rotor magnet 16 secured on an inner peripheral surface of the rotor peripheral wall portion 12b of the rotor hub 12.

<Configuration of Bearing>

The shaft 8 is inserted along the inner periphery of the sleeve 6, so that an inner peripheral surface of the sleeve 6 and a second outer peripheral surface 8b of the shaft 8 are arranged in radially opposed relation to each other through a second micro gap 42. The second micro gap holds the oil as a lubricating fluid, and is formed with the upper and lower radial bearing sections 26, 28 spaced from each other along the axial direction.

The upper radial bearing section 26 is formed with herring bone grooves having an unbalanced shape along the axial direction on the inner peripheral surface of the sleeve 6. With the rotation of the rotor hub 12, therefore, the pressure for moving the oil upward along the axial direction is induced.

The lower radial bearing section 28 is formed with an axially balanced herring bone grooves on the inner peripheral surface of the sleeve 6, so that with the rotation of the rotor hub 12, the pressure for moving the oil from the ends of the lower radial bearing section toward the center is induced.

An upper end surface of the sleeve 6 and a lower surface of the rotor upper wall portion 12a are arranged in opposed relation to each other axially through the first micro gap 40. The first micro gap 40 holds the oil and configures a thrust bearing section 14. The upper end surface 6a of the sleeve 6 is formed with a spiral grooves of pump-in type in such a manner that the oil is induced by the pressure to move radially inward (toward the shaft 8). The size of the first micro gap 40 is, for example, 300 μm or less and is preferably 100 μm or less.

The oil is retained continuously from the upper radial bearing section 26 to the thrust bearing section 14, i.e. from the second micro gap 42 to the first micro gap 40. The oil is induced by the pressure to move upward along the axial direction by the unbalanced herring bone grooves in the upper radial bearing section 26, and therefore the pressure is increased at a center or an upper part of the upper radial bearing section 26. In addition, the pressure is induced to move the oil radially inward due to the spiral grooves of pump-in type, and therefore the oil is refilled in the upper radial bearing section 26 of the thrust bearing section 14.

Specifically, the upper radial bearing section 26 and the thrust bearing section 14 collaborate with each other to apply the axial supporting force to the rotor hub 12 in radial direction and the axial supporting force in such an axial direction as to rise the bracket 2.

An annular notch 6e having a substantially L-shaped cross section inclined radially inward progressively downward is arranged at an upper end of an outer peripheral surface of the sleeve 6. The rotor upper wall portion 12a is formed with a peripheral protrusion 12d loosely fitted in the notch 6e out of contact with the notch 6e from the lower surface of the rotor upper wall portion 12a.

An size of an radial gap formed between an inner peripheral surface of the peripheral protrusion 12d and an outer peripheral surface of the notch 6e in radially opposed relation with the inner peripheral surface of the peripheral protrusion 12d is progressively increased downward in taper. At the radial outer end of the thrust bearing section 14, the inner peripheral surface of the peripheral protrusion 12d and the outer peripheral surface of the notch 6e collaborate with each other to make up a taper seal portion 10. The oil retained in the thrust bearing section 14 is formed with the meniscus boundary between the oil and the air in the taper seal portion 10, so that the surface tension of the oil and the atmospheric pressure are balanced with each other.

<Configuration of Clamp Member 22>

A clamp member 22 covering the rotor hub 12 is arranged above the rotor hub 12. The clamp member 22 is, for example, a disk-shaped elastic spring member formed of stainless steel, and has a radially inner base 22a and an operating section 22b arranged radially outward.

An base 22a of the clamp member 22 is pressed against the lower surface of the large-diameter portion of the fastening member 24 as an male screw of the fastening member 24 is forced into the threaded hole 8a of the shaft 8.

The recording disk 18 is stacked by being mounted on the outer periphery of the rotor hub 12 through a spacer 20. The lowest recording disk 18 is placed on a flange portion 12c of the rotor hub 12 and holds the recording disk by the pressure applied by the operating section 22b of the clamp member 22 to the uppermost recording disk 18.

Specifically, as the result of pressing the base 22a of the clamp member 22 against the fastening member 24, the pressure acting axially downward of the fastening member 24 is transmitted from a lower surface of a lager-diameter portion of the fastening member 24 to an upper end surface of the base 22a of the clamp member 22. The clamp member 22 is pressed axially downward, and the pressure of the fastening member 24 is transmitted to the operating section 2b from the base 22a of the clamp member 22. After that, the operating section 22b axially holds the recording disk 18 and the spacer 20 with the upper surface of the flange portion 12c. By the way, one or a plurality of recording disks can be mounted.

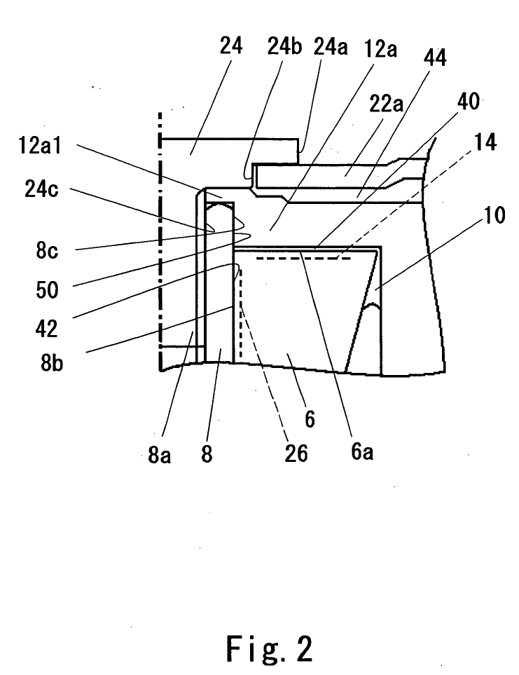

Next, the configuration and the operational effects of the essential parts according to the invention are explained with reference to FIG. 2.

FIG. 2 is a partly enlarged sectional view showing the configuration for restricting the amount of the downward fastening force of the fastening member 24 of the recording disk driving motor shown in FIG. 1. The fastening member 24 includes a large-diameter portion 24a, a middle-diameter portion 24b smaller in diameter than the large-diameter portion 24a and a small-diameter portion 24c smaller in diameter than the middle-diameter portion.

The inner end of the rotor upper wall portion 12a is formed with an annular protrusion 12a1 extending radially inward from the inner peripheral portion of rotor upper wall portion 12a as a position restricting portion. When the inner peripheral surface of the rotor upper wall portion 12a is fitted on the first outer peripheral surface 8c of the shaft 8, the lower surface of the protrusion 12a1 comes into contact with the upper end surface of the shaft 8, while the upper surface thereof comes into contact with the lower surface of the middle-diameter portion of the fastening member 24. The protrusion 12a1 is wedged between the fastening member 24 and the shaft 8. Also, a coupling portion 50 is formed between the first outer peripheral surface 8c of the shaft 8 and the inner peripheral surface of the rotor upper wall portion 12a.

The first outer peripheral surface 8c of the shaft 8 and the second outer peripheral surface 8b are aligned substantially in the axial direction. As a result, the outer diameter of the coupling portion 50 is increased, and therefore the rigidity of the shaft 8 is improved. Also, the working efficiency is improved, and therefore the shaft 8 can be fabricated at low cost thereby to reduce the working cost.

Once the fastening member 24 is forced into the threaded hole 8a, the lower end surface of the large-diameter portion 24a of the fastening member 24 and the upper end surface of the base 22a of the clamp member 22 come into contact with each other, so that the small-diameter portion 24c of the fastening member 24 and the side end portion of the protrusion 12a1 of the rotor upper wall portion 12a come into radially opposed relation to each other through a gap.

In the process, the clamp member 22 is pushed down. Since the protrusion 12a1 of the rotor upper wall portion 12a comes into contact with the fastening member 24, however, the amount by which the fastening member 24 is fastened downward with respect to the threaded hole 8a is restricted, and therefore the lower end surface of the base 22a of the clamp member 22 and the upper end surface of the upper wall portion 12a of the rotor hub 12 come into opposed relation to each other through the axial gap 44.

The axial gap 44 prevents the rotor upper wall portion 12a from being deformed by the pressure which is imparted from the fastening member 24 to the clamp member 22 and would have been transmitted to the rotor upper wall portion 12a. Otherwise, the deformation of the rotor upper wall portion 12a would cause the rotor upper wall portion 12a and the sleeve 6 to come into contact with each other when the rotor is rotated, thereby preventing the wearing and damaging or burning of the lower surface of the rotor upper wall portion 12a and the upper end surface of the sleeve 6. Thus, a recording disk driving motor high in durability and reliability is provided.

In this way, the size of the first micro gap of the thrust bearing section 14 can be kept substantially uniform, while at the same time stabilizing the dynamic pressure induced by the pumping of the dynamic pressure generating groove thereby to secure a stable shaft supporting force of the thrust bearing section.

Also, the fact that the lower surface of the protrusion 12a1 comes into contact with the upper end surface of the shaft 8 restricts the axial position of the rotor hub 12.

The size in axial direction of the protrusion 12a1 of the rotor upper wall portion 12a is so set that the axial gap 44 is formed and balanced with the force at which the operating section 2b of the clamp member 22 holds the recording disk 18 with the flange portion 12c.

Also, the protrusion 12a1 may alternatively be formed of a plurality of protrusions arranged through the gap along the circumferential direction.

### Second Embodiment

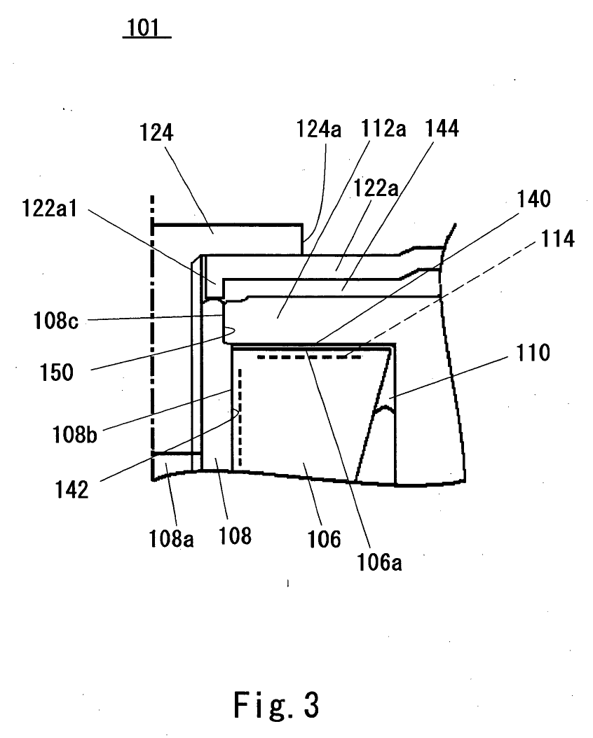

FIG. 3 is a partly enlarged sectional view showing the second embodiment of the invention. The recording disk driving motor according to the second embodiment has a basically similar structure as that of the first embodiment. The corresponding parts, therefore, are designated by the corresponding reference numbers on the hundredth order, while only different component parts are explained.

In FIG. 3, a first outer peripheral surface 108c located above and smaller in diameter than a second outer peripheral surface 108b is formed on the upper outer peripheral surface of the shaft 108. The inner peripheral surface of the rotor upper wall portion 112a is fixedly fitted on the first outer peripheral surface 108c, and a coupling portion 150 is formed in the part from which the inner peripheral surface of the rotor upper wall portion 112a is fixedly fitted on the first outer peripheral surface 108c. As a result, the axially downward motion of the rotor hub 122 is restricted. Due to this configuration, the first micro gap 140 between the lower surface of the rotor upper wall portion 112a and the upper end surface of the sleeve 106 can be formed in substantially equal size along the peripheral direction.

The fastening member 124 includes a large-diameter portion 124a and a small-diameter portion 124c located under the large-diameter portion 124a.

The lower end of the base 122a of the clamp member 122 is formed with an annular protrusion 122a1 as a position restricting portion. Once the fastening member 124 is forced into the threaded hole 108a of the shaft 108, the downward pressure of the fastening member 124 pushes down the clamp member 122. The downward motion of the fastening member 124 is restricted, however, by the fact that both upper and lower portion of the protrusion 122a1 of the clamp member 122 comes into contact with the upper end portion of the shaft 108 and lower surface of the large-diameter portion 124a.

In the process, an axial gap 144 is formed between the lower end of the base 122a of the clamp member 122 and the upper end of the rotor upper wall portion 112a. And, the lower end surface of the large-diameter portion 124a of the fastening member 124 and the upper end surface of the base 122a of the clamp member 122 come into contact with each other, while the small-diameter portion 124c of the fastening member 124 and the inner peripheral surface of the protrusion 122a1 of the clamp member 122 come into radially opposed relation to each other through the gap.

The axial gap 144 prevents the rotor upper wall portion 112a from being deformed by the pressure which is imparted from the fastening member 124 to the clamp member 122 and would otherwise be transmitted to the rotor upper wall portion 112a.

The protrusion 122a1 of the clamp member 122 is formed to such an axial size that the axial gap 144 is formed and balanced with the force at which the operating section 122b of the clamp member 122 holds the recording disk 118 with the flange portion 112c. Alternatively, the protrusion 122a1 of the clamp member 122 may be formed of a plurality of protrusions arranged in spaced relation with each other along the circumferential direction.

### Third Embodiment

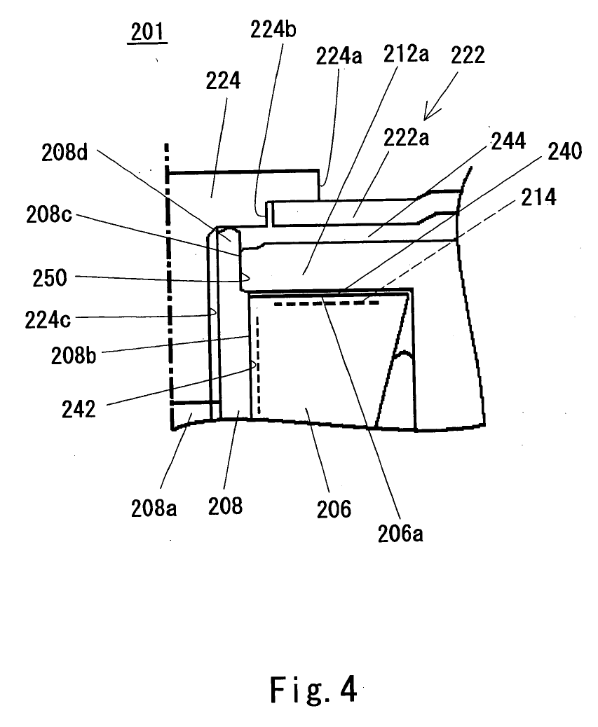

FIG. 4 is a partly enlarged sectional view showing a third embodiment of the invention. The recording disk driving motor according to the third embodiment has basically the same structure as that of the first embodiment. Therefore, the corresponding component parts are designated by the corresponding reference numerals on the two-hundredth order, and only different component parts are explained.

The fastening member 224 includes a large-diameter portion 224a as an outermost portion, a middle-diameter portion 224b smaller in diameter than the large-diameter portion 224a and a small-diameter portion 224c smaller in diameter than the middle-diameter portion 224b.

The upper end of the shaft 208 is formed with a cylindrical protrusion 208d making up a position restricting portion extending axially upward from the upper end surface of the rotor upper wall portion 212a.

Once the fastening member 224 is forced into the threaded hole 208a, the lower end surface of the large-diameter portion 224a of the fastening member 224 and the upper end surface of the base 222a of the clamp member 222 come into contact with each other.

In the process, the clamp member 222 is pushed down. The contact between the protrusion 208d of the shaft 208 and the fastening member 224, however, restricts the fastening force of the fastening member 224 downward in the threaded hole 208a. Therefore, the lower end surface of the base 222a of the clamp member 222 and the upper end surface of the upper wall portion 212a of the rotor hub 212 come into opposed relation to each other through the axial gap 244.

The axial gap 244 prevents the rotor upper wall portion 212a from being deformed by the pressure which is imparted from the fastening member 224 to the clamp member 222 and otherwise would be transmitted to the rotor upper wall portion 212a.

The protrusion 208d of the shaft 208 is set to such an axial size that the axial gap 244 is formed and balanced with the force at which the operating section 222b of the clamp member 222 holds the recording disk with the flange portion 212c.

And, the protrusion 208d may alternatively formed of a plurality of protrusions arranged in spaced relation to each other along the circumferential direction.

<Recording Disk Driving Apparatus>

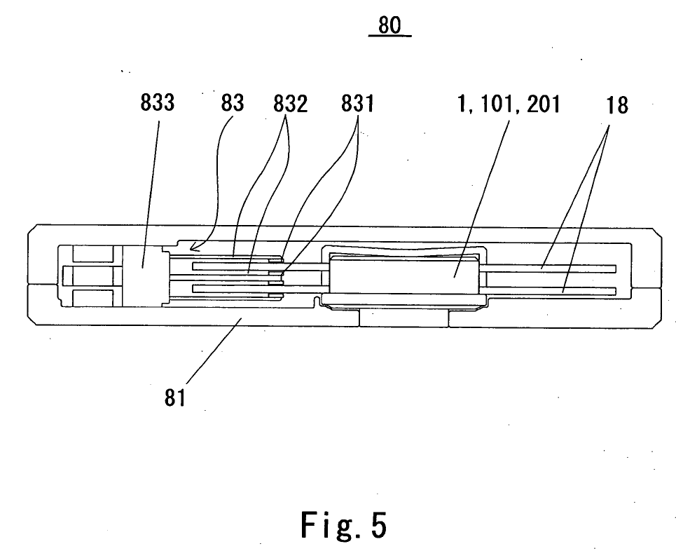

FIG. 5 is a longitudinal section showing the internal configuration of a recording disk driving apparatus 80 to which the recording disk driving motor (1, 101, and 201) is attached. The recording disk driving apparatus 80 is a small electronic device and is used for, for example, a notebook-sized personal computer or small electronic notepad. The inside of the recording disk driving apparatus 80 is a clean space having little dusts because of a housing 81. The housing 81 houses a recording disk 18 as a recording medium having a disc shape (for example, a disk having a diameter of one inch (25.4 mm)), an access unit 83 for writing and (or) reading information to/from the recording disk 18, and the recording disk driving motor (1, 101, and 201) for rotating the recording disk 18.

The access unit 83 has: a head 831 which is disposed near the recording disk 18 and magnetically writes/reads information to/from the recording disk 18; an arm 832 for supporting the head 831, and a head moving mechanism 833 for changing the relative positions of the head 831 and the recording disk 18 by moving the arm 832. With the configuration, the head 831 accesses a required position in the recording disk 18 in a state where it is close to the rotating recording disk 18 to write/read information.

By using the recording disk driving motor (1, 101, and 201) of the invention for the recording disk driving apparatus 80, the smaller, thinner, and cheaper recording disk driving apparatus 80 having excellent reliability and durability is realized.

A recording disk driving motor and a recording disk driving apparatus comprising the motor according to an embodiment of the invention are described above. This invention, however, is not limited to this embodiment, but can be variously altered or modified without departing from the scope of the invention.

Although the embodiment described above uses the oil as a lubricating fluid for the fluid dynamic bearing, the invention is also applicable to a motor having what is called the gas dynamic bearing using the gas as a fluid.

And, as long as the pressure of the clamp member pressed by the fastening member forced into the threaded hole of the shaft is not transmitted directly to the thrust bearing section through the rotor upper wall portion, the invention is also applicable to a structure in which the base of the clamp member comes into contact with the rotor upper wall portion.

What is claimed is:

1. A recording disk driving motor with a recording disk held on an outer periphery thereof, the recording disk fixed to the outer periphery of the motor by a pressure of a clamp member, the pressure transferred from a fastening member fastened on an upper part of the motor to the clamp member, comprising:
a cylindrical sleeve;
a bracket for fixing the sleeve;
a stator fixed on the outer peripheral surface of the sleeve or the bracket;
a shaft rotating around a rotational axis relatively to the sleeve and having a threaded hole formed on an upper end surface of the shaft and extending downward on the rotational axis in the shaft, the threaded hole to which the fastening member is fastened;
a rotor hub fixed on an upper part of the shaft and including a rotor upper wall portion formed a disk like shape and a rotor peripheral wall portion extending downward in axial direction from an outer periphery of the rotor upper wall portion, an outer peripheral surface of the rotor upper wall portion on which the recording disk is held;
a rotor magnet secured on the rotor peripheral wall portion in such a manner as to be radially opposed to the stator;
a thrust bearing section including a lubricating fluid filled as a working fluid in a first micro gap which is formed between a lower surface of the rotor upper wall portion and an upper end surface of the sleeve, and dynamic pressure generating grooves formed on at least one side of the lower surface of the rotor upper wall portion and the upper end surface of the sleeve, for generating a dynamic pressure so as to support a relative rotation between the shaft and the sleeve; and
a position restricting portion for restricting a position of the fastening member after the fastening member is fastened in the threaded hole of the shaft, the position restricting portion is arranged between the fastening member and the upper part of the motor, wherein the pressure of the clamp member is not directly transferred to the thrust bearing section through the rotor upper wall portion when the fastening member is fastened.

2. A recording disk driving motor according to claim 1, wherein the position restricting portion is formed integrally with the rotor upper wall portion and extends radially inner direction than a first outer peripheral surface which is formed on an upper part of the shaft, the position restricting portion is wedged between the upper end of the shaft and a lower surface of the fastening member.

3. A recording disk driving motor according to claim 2, wherein the recording disk driving motor further comprises;
a second micro gap formed between a second outer peripheral surface of the shaft located at a lower location than the first outer peripheral surface of the shaft and an inner peripheral surface of the sleeve, the lubricating fluid is retained continuously in the first micro gap and in the second micro gap, and
a radial bearing section including the lubricating fluid filled in the second micro gap, and dynamic pressure generating grooves formed on at least one side of the second outer peripheral surface of the shaft and the inner peripheral surface of the sleeve, for generating a dynamic pressure so as to support a relative rotation between the shaft and the sleeve,
wherein the first outer peripheral surface of the shaft is aligned substantially with the second outer peripheral surface in axial direction.

4. A recording disk driving motor according to claim 1, wherein the position restricting portion is formed integrally with the axially upper part of the shaft and projected axially upward from the upper end of the rotor upper wall portion, the fastening member is forced into the threaded hole of the shaft so that the position restricting portion is brought into contact with the fastening member.

5. A recording disk driving motor according to claim 4, wherein the recording disk driving motor further comprises:
a second micro gap formed between a second outer peripheral surface of the shaft located at a lower location than the first outer peripheral surface of the shaft and an inner peripheral surface of the sleeve, the lubricating fluid is retained continuously in the first micro gap and in the second micro gap, and
a radial bearing section including the lubricating fluid filled in the second micro gap, and dynamic pressure generating grooves formed on at least one side of the second outer peripheral surface of the shaft and the inner peripheral surface of the sleeve, for generating a dynamic pressure so as to support a relative rotation between the shaft and the sleeve,
wherein the first outer peripheral surface of the shaft is smaller in diameter than the second outer peripheral surface.

6. A recording disk driving apparatus having the recording disk driving motor according to claim 1, further comprising:
the fastening member fastened to the upper part of the recording disk driving motor;
the clamp member mounted on the recording disk driving motor to fix the recording disk by the pressure transferred from the fastening member;
the recording disk held on the outer periphery of the motor by the pressure of the clamp member;
an access unit for reading and writing the information from and onto the recording disk; and
a housing for accommodating the recording disk, the recording disk driving motor and the access unit in the manner isolated from an external space.

7. A recording disk driving apparatus comprising:
a housing;
a recording disk driving motor fixed in the housing;
a fastening member fixed to an upper part of the recording disk driving motor;
a clamp member mounted on the recording disk driving motor to fix the recording disk by a pressure transferred by the fastening member when fastened to the recording disk driving motor;
a recording disk held on an outer periphery of the recording disk driving motor by using a pressure transferred from the clamp member; and
an access unit for reading and writing information from and into the recording disk; wherein the recording disk driving motor comprises:
a cylindrical sleeve;
a bracket for fixing the sleeve;
a stator fixed on the outer peripheral surface of the sleeve or the bracket;
a shaft rotating around a rotational axis relatively to the sleeve and having a threaded hole formed on an upper end surface of the shaft and extending downward on the rotational axis in the shaft, the threaded hole to which the fastening member is fastened;
a rotor hub fixed on an upper part of the shaft and including a rotor upper wall portion formed a disk like shape and a rotor peripheral wall portion extending downward in axial direction from an outer periphery of the rotor upper wall portion, an outer peripheral surface of the rotor upper wall portion on which the recording disk is held;
a rotor magnet secured on the rotor peripheral wall portion in such a manner as to be radially opposed to the stator;
a thrust bearing section including a lubricating fluid filled as a working fluid in a first micro gap which is formed between a lower surface of the rotor upper wall portion and an upper end surface of the sleeve, and dynamic pressure generating grooves formed on at least one side of the lower surface of the rotor upper wall portion and the upper end surface of the sleeve, for generating a dynamic pressure so as to support a relative rotation between the shaft and the sleeve; and
a position restricting portion for restricting a position of the fastening member after the fastening member is fastened in the threaded hole of the shaft, the position restricting portion is arranged between the fastening member and the upper part of the motor, wherein the pressure of the clamp member is not directly transferred to the thrust bearing section through the rotor upper wall portion when the fastening member is fastened.

8. A recording disk driving apparatus according to claim 7, wherein the position restricting portion is formed integrally with the rotor upper wall portion and extends radially inner direction than a first outer peripheral surface which is formed on an upper part of the shaft, the position restricting portion is wedged between the upper end of the shaft and a lower surface of the fastening member.

9. A recording disk driving apparatus according to claim 8, wherein the recording disk driving motor further comprises;
a second micro gap formed between a second outer peripheral surface of the shaft located at a lower location than the first outer peripheral surface of the shaft and an inner peripheral surface of the sleeve, the lubricating fluid is retained continuously in the first micro gap and in the second micro gap, and
a radial bearing section including the lubricating fluid filled in the second micro gap, and dynamic pressure generating grooves formed on at least one side of the second outer peripheral surface of the shaft and the inner peripheral surface of the sleeve, for generating a dynamic pressure so as to support a relative rotation between the shaft and the sleeve,
wherein the first outer peripheral surface of the shaft is aligned substantially with the second outer peripheral surface in axial direction.

10. A recording disk driving apparatus according to claim 7, wherein the position restricting portion is formed integrally with the axially upper part of the shaft and projected axially upward from the upper end of the rotor upper wall portion, the fastening member is forced into the threaded hole of the shaft so that the position restricting portion is brought into contact with the fastening member.

11. A recording disk driving apparatus according to claim 10, wherein the recording disk driving motor further comprises:
a second micro gap formed between a second outer peripheral surface of the shaft located at a lower location than the first outer peripheral surface of the shaft and an inner peripheral surface of the sleeve, the lubricating fluid is retained continuously in the first micro gap and in the second micro gap, and
a radial bearing section including the lubricating fluid filled in the second micro gap, and dynamic pressure generating grooves formed on at least one side of the second outer peripheral surface of the shaft and the inner peripheral surface of the sleeve, for generating a dynamic pressure so as to support a relative rotation between the shaft and the sleeve,
wherein the first outer peripheral surface of the shaft is smaller in diameter than the second outer peripheral surface.

12. A recording disk driving apparatus according to claim 7, wherein the position restricting portion is formed integrally with the clamp member at an inner peripheral edge thereof and extending axially downward from the inner peripheral edge of the clamp member, both upper and lower surface of the position restricting portion being in contact with the fastening member and the upper end of the shaft by the fastening force caused by which the fastening member is fastened into the threaded hole.

13. A recording disk driving apparatus according to claim 12, wherein the recording disk driving motor further comprises:
a second micro gap formed between a second outer peripheral surface of the shaft located at a lower location than the first outer peripheral surface of the shaft and an inner peripheral surface of the sleeve, the lubricating fluid is retained continuously in the first micro gap and in the second micro gap, and
a radial bearing section including the lubricating fluid filled in the second micro gap, and dynamic pressure generating grooves formed on at least one side of the second outer peripheral surface of the shaft and the inner peripheral surface of the sleeve, for generating a dynamic pressure so as to support a relative rotation between the shaft and the sleeve,
wherein the first outer peripheral surface of the shaft is smaller in diameter than the second outer peripheral surface.

14. A recording disk driving apparatus according to claim 7, wherein a axial gap is formed between a lower surface of the clamp member and an upper surface of the rotor upper wall portion, whereby the pressure of the clamp member is not directly transferred to the thrust bearing section through the rotor upper wall portion when the fastening member is fastened.
